(19) United States
(12) Patent Application Publication
(10) Pub. No.: US 2010/0176184 A1
(43) Pub. Date: Jul. 15, 2010

(54) ULTRASONIC WELDING USING AMPLITUDE PROFILING

(75) Inventors: James F. Sheehan, Wilmington, MA (US); David A. Grewell, Ames, IA (US)

Correspondence Address: HARNESS, DICKEY & PIERCE, P.L.C., P.O. BOX 828, BLOOMFIELD HILLS, MI, 48303, US

(73) Assignee: Branson Ultrasonics Corporation, Danbury, CT (US)

(21) Appl. No.: 12/730,606

(22) Filed: Mar. 24, 2010

Related U.S. Application Data
(62) Division of application No. 11/837,702, filed on Aug. 13, 2007.
(60) Provisional application No. 60/842,131, filed on Sep. 1, 2006.

(51) Int. Cl. B23K 20/10

(52) U.S. Cl. 228/110.1

(57) ABSTRACT

A method of ultrasonic welding aluminum parts together includes placing the aluminum parts in an ultrasonic welding apparatus and contacting at least one of the aluminum parts with a horn tip of a weld horn of the ultrasonic welding apparatus. A weld amplitude is profiled during a weld cycle of the ultrasonic welding apparatus by producing a high weld amplitude above 55 μm at the horn tip of the weld horn during an initial period of a weld cycle and producing a low weld amplitude below 55 μm at the horn tip after the initial period.

### CROSS-REFERENCE TO RELATED APPLICATIONS

This application is a divisional of U.S. patent application Ser. No. 11/837,702 filed on Aug. 13, 2007, which is a non-provisional application of U.S. Provisional Application No. 60/842,131 filed on Sep. 1, 2006. The entire disclosures of the above applications are incorporated herein by reference.

### GOVERNMENT RIGHTS

The U.S. Government has a paid-up license in this invention and the right in limited circumstances to license other on reasonable terms as provided for by the terms of NIST ATP #70NANB3H3015 awarded by the Department of Commerce.

### FIELD OF THE INVENTION

The present invention relates to an ultrasonic welding apparatus and method, and more particularly to an ultrasonic apparatus and method for welding by vibrations applied in a direction parallel to the work piece surface, also known as shear wave vibrations.

### BACKGROUND OF THE INVENTION

A model of a typical ultrasonic metal welding apparatus 100 is shown in FIG. 1. Typical components of ultrasonic metal welding apparatus 100 include an ultrasonic transducer 102, a booster 104, and an ultrasonic horn 106. Booster 104 is coupled to transducer 102 and horn 106 by polar mounts (not shown) which are, at outer circumferential edges, mounted to opposed ends of a cylinder 105. Electrical energy from a power supply 101 at a frequency of 20-60 kHz is converted to mechanical energy by the ultrasonic transducer 102. The ultrasonic transducer 102, booster 104, and horn 106 are all mechanically tuned to match the power supply electrical input frequency. The mechanical energy converted in the ultrasonic transducer 102 is transmitted to a weld load 108 (such as two pieces of metal 112, 114) through the booster 104 and the horn 106 (which are typically ½ wave axial resonant tools). The booster 104 and the horn 106 perform the functions of transmitting the mechanical energy as well as transforming mechanical vibrations from the ultrasonic transducer 102 by a gain factor. Booster gains typically run from 1:0.5 to 1:2. Horn gains typically run from 1:1 to 1:3. Booster and horn gains take an output amplitude (from the ultrasonic transducer 102) of 20 μm peak to peak and factor this amplitude up or down.

The mechanical vibration that results on a horn tip 110 is the motion that performs the task of welding metal together. Essentially an axial displacement is produced by the ultrasonic transducer 102, modified in gain by the booster 104, and again modified in gain by the horn 106. The metal pieces 112, 114 to be welded together are placed adjacent to the weld tip (horn tip 110). As a perpendicular force (shown by arrows 116) is applied to weld stack 118 (ultrasonic transducer 102, booster 104 and horn 106), the horn tip 110 will come in contact with top metal piece 112 to be welded. The axial vibrations of the ultrasonic horn 106 now become shear vibrations to the top metal piece 112. As the weld clamp force 116 is increased, the shear vibrations will increasingly be transmitted to the top metal piece 112, causing it to move back and forth. A weld anvil 120 grounds the bottom metal piece 114. The back and forth motion of the top metal piece 112 relative to the bottom metal piece 114 will scrub the oxides and contaminates away from the surfaces of metal pieces 112, 114 that are in contact with each other. After an amount of time under this shear motion and clamp force, the metal material in the weld area between the two metal pieces 112, 114 will become entangled and eventually bond.

The amount of amplitude needed at the horn tip 110 is typically a function of the material being welded and time required for bonding. Use of greater weld amplitude at the horn tip 110 will cause more electrical power to be converted in the ultrasonic transducer 102 and lead to bonding of weld material in shorter times. Use of lower amplitude at the weld tip 110 will cause less electrical power to be converted in the ultrasonic transducer 102 and lead to bonding of weld material in longer times. A designation of weld amplitude at the horn tip 110 will dictate the design of the gain factors of the horn 106 and booster 104 combination since the output of the ultrasonic transducer 102 is typically fixed, for example, 20 microns (μm) peak to peak.

The material being welded will also dictate how much amplitude is required at the horn tip 110. Typical horn amplitudes used in metal welding range from 40 μm to 80 μm (peak to peak). In the case of aluminum, amplitudes above 50-60 μm (peak to peak) become problematic. At higher horn amplitudes, there is a tendency to heat the aluminum and cause it to soften. If the interface area of the top metal piece 112 softens enough, the horn tip 110 will penetrate into the top metal piece 112 and weaken the parent material, which compromises the weld quality. Typically in aluminum welding, it is generally desirable that the horn amplitude remain below 55 μm (peak to peak) for this reason.

FIG. 2 is a chart that shows weld strength as a function of energy for 3 mm thick aluminum 5754 samples ultrasonically welded using various constant weld amplitudes. The maximum weld strength achieved was about 7500 Newtons (N) or less. That is, with a relatively high constant weld amplitude (64 μm) the weld strength is about 4200 N and with a relatively low constant weld amplitude (40 μm) the weld strength is about 7500 N.

### SUMMARY OF THE INVENTION

A method of ultrasonic welding aluminum parts together in accordance with an aspect of the present invention includes placing the aluminum parts in an ultrasonic welding apparatus and contacting at least one of the aluminum parts with a horn tip of a weld horn of the ultrasonic welding apparatus. A weld amplitude is profiled during a weld cycle of the ultrasonic welding apparatus by producing a high weld amplitude above 55 μm at the horn tip of the weld horn during an initial period of a weld cycle and producing a low weld amplitude below 55 μm at the horn tip after the initial period. In an aspect, the aluminum parts are each at least about 3 mm thick.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a prior art ultrasonic welding apparatus;

FIG. 2 is a chart that shows weld strength as a function of energy for 3 mm thick aluminum 5754 samples ultrasonically welded using various constant weld amplitudes;

FIG. 3 is a schematic view of an ultrasonic welding apparatus using amplitude profiling in accordance with an aspect of the invention;

FIG. 4 is a flow chart of a method of ultrasonically welding using amplitude profiling in accordance with an aspect of the invention; and

FIG. 5 is a series of charts showing voltage and power during a typical prior art ultrasonic weld cycle;

FIG. 6 is a graph of test results comparing 3 mm 5734 aluminum welded using amplitude profiling (60 μm and 40 μm weld amplitudes) with 3 mm 5734 aluminum welded at fixed 60 μm and fixed 40 μm weld amplitudes with a flexible anvil;

FIG. 7 is a graph of test results comparing 3 mm 5734 aluminum welded using amplitude profiling (60 μm and 40 μm weld amplitudes) with 3 mm 5734 aluminum welded at fixed 60 μm and fixed 40 μm weld amplitudes with a fixed anvil (loose anvil block);

FIG. 8 is a graph of test results comparing 3 mm 5734 aluminum welded using amplitude profiling (60 μm and 40 μm weld amplitudes) with 3 mm 5734 aluminum welded using a fixed 60 μm weld amplitudes with a fixed anvil (fixed anvil block);

FIG. 9 is a graph of test results showing 25 samples of 3 mm 5734 aluminum welded using amplitude profiling with a flexible anvil; and

FIG. 10 is a graph of test results showing 25 samples of 3 mm 5734 aluminum welded using amplitude profiling with a fixed anvil.

### DETAILED DESCRIPTION OF THE PREFERRED EMBODIMENTS

The following description of the preferred embodiment(s) is merely exemplary in nature and is in no way intended to limit the invention, its application, or uses.

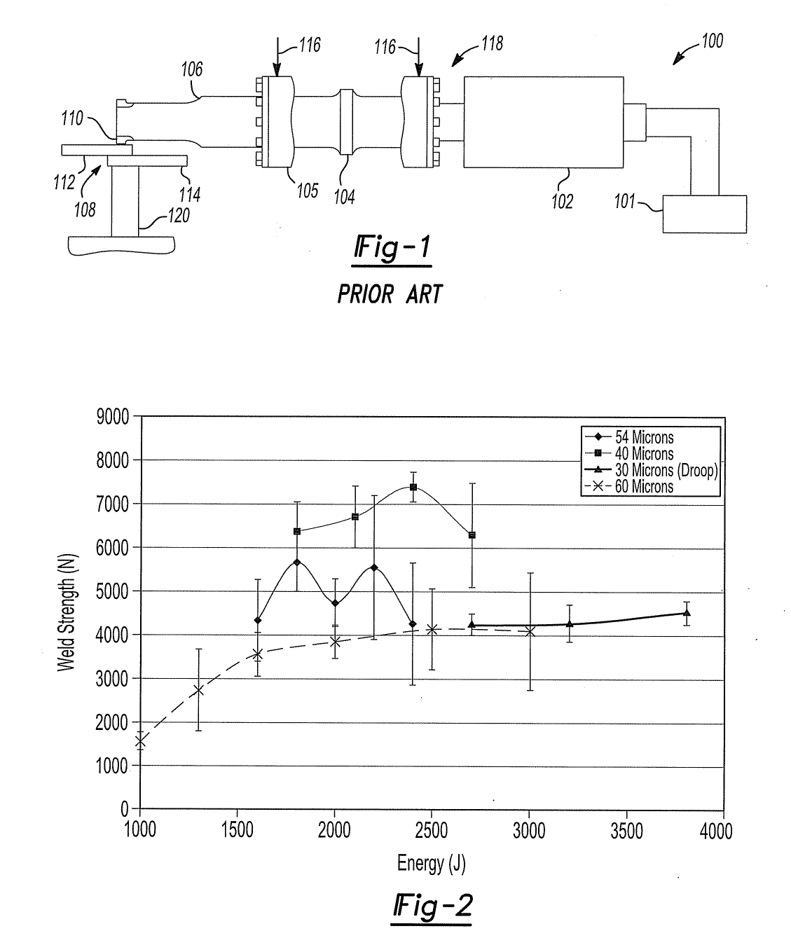

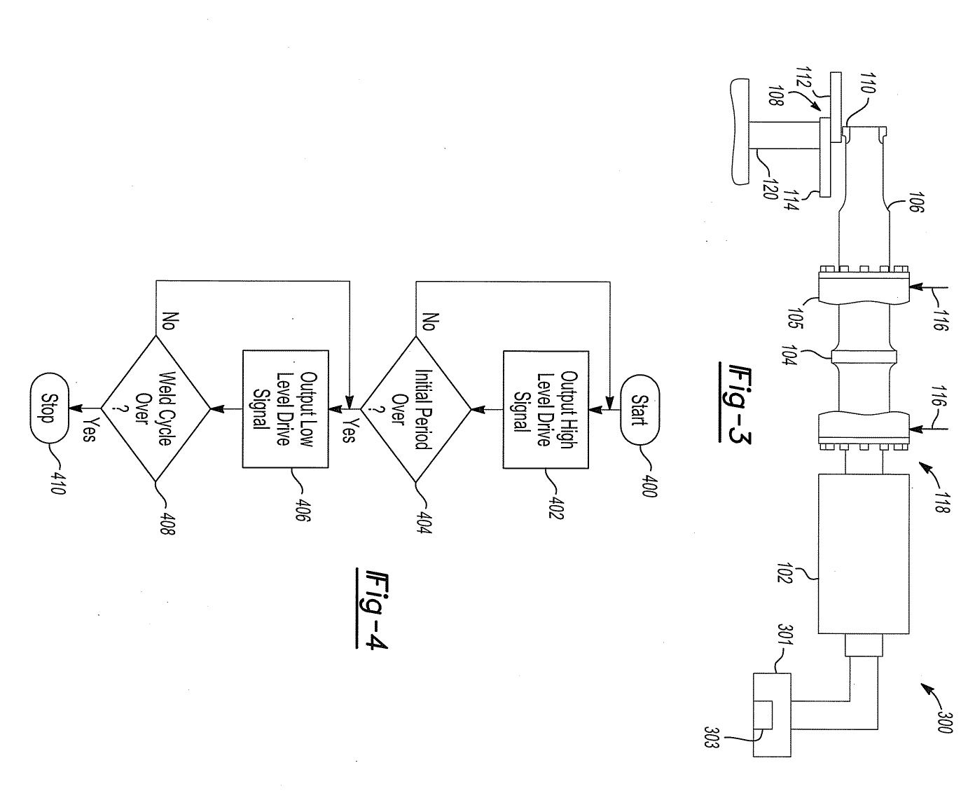

With reference to FIG. 3, an ultrasonic welding apparatus 300 utilizing amplitude profiling in accordance with an aspect of the invention is shown. Elements common to the elements of ultrasonic welding apparatus 100 of FIG. 1 will be identified with like reference numbers, and the discussion will focus on the differences. In ultrasonic welding apparatus 300, power supply 301 is configured, such as by appropriate programming of a controller 303 that controls power supply 301, to drive ultrasonic transducer 102 to produce amplitude profiling of a weld amplitude produced at horn tip 110 of horn 106 as described below.

FIG. 4 is a flow chart showing amplitude profiling in accordance with an aspect of the invention. Power supply 301 of ultrasonic welding apparatus 300 is configured to implement this amplitude profiling. The weld cycle begins at 400 and at 402, power supply 301 outputs a drive signal at a first (high) level to drive ultrasonic transducer 102 to produce a high weld amplitude at horn tip 110. Power supply 301 continues to output the drive signal at the first level for an initial period of the weld cycle. Upon a determination that the initial period expired at 404, the power supply 301 then lowers the drive signal at 406 to a second (low) level which is lower than the first level to produce a low weld amplitude at horn tip 110. Power supply 301 then drives the ultrasonic transducer 102 at this low level for the remainder of the weld cycle. Upon a determination at 408 that the weld cycle has completed, the welding is stopped at 410.

Amplitude profiling as used herein means starting the weld cycle with the high weld amplitude and then dropping the weld amplitude to the low weld amplitude after the initial period of the weld cycle. While the amplitude profiling described above involves one change in weld amplitude, it should be understood that the weld amplitude could be changed more than once. It should also be understood that more than two weld amplitudes can be used. The “trigger point” to determine when the initial period of the weld cycle ends, that is, for the transition between the high weld amplitude and the low weld amplitude, may illustratively be time. It should be understood that other trigger points can be used to determine when the transition is to occur, such as energy level and peak power value.

By ultrasonically welding aluminum using amplitude profiling, applicants have found that higher weld strengths can be achieved than are typically achieved using a constant weld amplitude. For example, in welding 3 mm thick samples of 5754 aluminum using amplitude profiling where the high weld amplitude was 64 μm which was reduced to 43 μm after 0.2 seconds into the weld cycle, a weld strength as high as 8800 N was achieved. Further, marking at the interface of horn tip 110 to the part, such as top metal piece 112, was reduced compared to welding at a constant weld amplitude.

Amplitude profiling also allows a higher weld amplitude to used for the initial weld amplitude than when a constant weld amplitude is used. As discussed above, in welding aluminum, the weld amplitude typically needs to be kept below 55 μm. With amplitude profiling, the initial high weld amplitude can exceed 55 μm. For example, the initial high weld amplitude can be 64 μm.

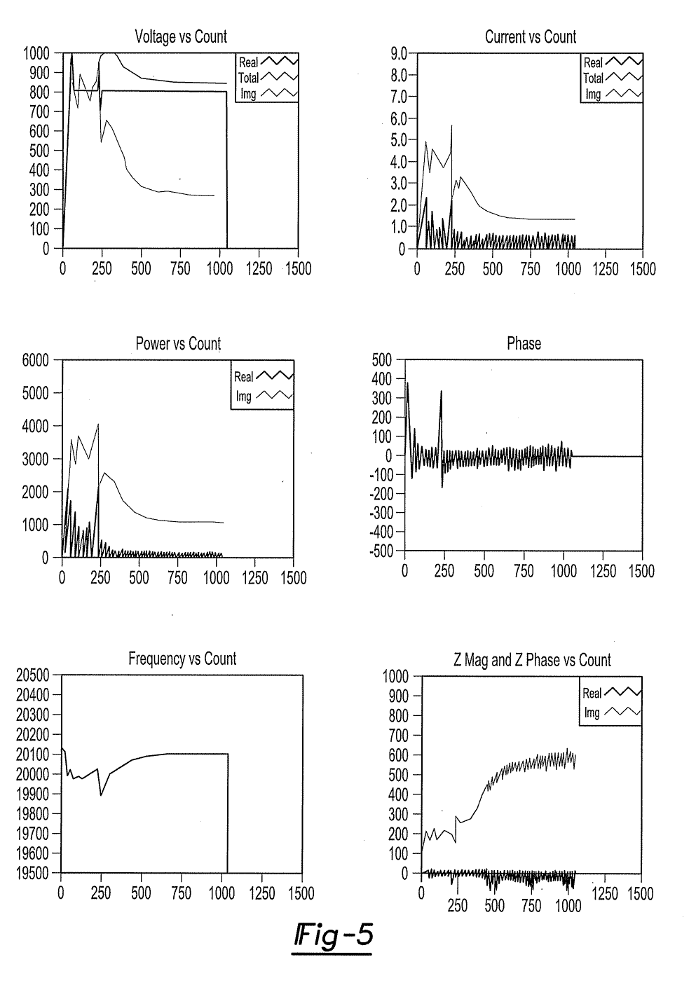

Applicants believe that the increase in weld strength obtained by ultrasonically welding using amplitude profiling is caused by artificially producing the ideal power profile for the weld cycle. For example, the power curve of an ultrasonic weld cycle in welding aluminum follows a trend where it is relatively high at the beginning of the weld cycle and then drops off near the end of the weld cycle. This is true even when the motional voltage/amplitude at ultrasonic transducer 102 remains constant. FIG. 5 is a series of charts showing voltage, power and other weld parameters during a typical prior art weld cycle using constant weld amplitude.

Although ultrasonic transducer 102 is driven with a constant level drive signal in the prior art weld cycle using constant weld amplitude, the actual weld amplitude at horn tip 110 tends to droop off during the weld cycle. Applicants believe that this drop off occurs because the weld amplitude at horn tip 110 is high while the weld nugget grows and the relative stiffness of the system (metal pieces 112, 114 and the interface of metal piece 112 with horn tip 110) is low. As the weld cycle progresses, the weld nugget grows and the system becomes stiffer. The stiffer weld pieces (metal pieces 112, 114) cause the weld amplitude at horn tip 110 to reduce due to mechanical deformation of the horn tip 110. This reduction in weld amplitude at horn tip 110 tends to prevent damage to the weld due to excessive shearing that would normally occur if the weld amplitude at horn tip 110 remained high (and constant) during the entire weld cycle. But in some cases, this natural droop does not occur with the result that the weld strength is lower than when the natural droop occurs. This results in welds having inconsistent weld strengths. By welding using amplitude profiling in accordance with the invention, the reduction of weld amplitude at horn tip 110 is assured and the resulting welds are consistently strong.

A benefit of ultrasonically welding using amplitude profiling in accordance with the invention is high sample pull strength with reduced part marking. Ultrasonic welding with a constant high amplitude produces, as discussed above, a great deal of surface heat in aluminum which can soften the metal piece 112 at the interface with horn tip 110. As metal piece 112 softens, the horn tip 110 will penetrate into it, producing a deep horn tip mark. In the case of aluminum, this penetration also produces an excessive amount of part to horn tip sticking following completion of the weld.

Applicants have found that ultrasonically welding aluminum using amplitude profiling appears to reduce the softening effect in the aluminum part being welded that is adjacent horn tip 110 (e.g. top metal piece 112). During the initial period where the weld amplitude is high, energy is rapidly input into the weld nugget formation. As the material of the parts being welded, such as metal pieces 112, 114, nears the softening point (about 0.4-0.5 seconds in 5754 aluminum where the initial weld amplitude is 64 μm), the weld amplitude is dropped to the lower second weld amplitude (such as 43 μm) which drops the rate of energy input into the weld nugget for the remainder of the weld cycle. This allows the weld nugget to grow without the metal piece 112 adjacent horn tip 110 softening. Reduced material softening of the metal piece 112 adjacent horn tip 110 reduces penetration of metal piece 112 by horn tip 110 and greatly reduces sticking between metal piece 112 and horn tip 110.

In an aspect, the material being welded is aluminum and the high weld amplitude is above 55 μm and the low weld amplitude is below 55 μm. In an aspect, the material being welded is aluminum and the high weld amplitude is above 60 μm and the low weld amplitude is below 50 μm. In an aspect, the material being welded is aluminum and the high weld amplitude is above 60 μm and the low weld amplitude is below 45 μm. In an aspect, the high weld amplitude is at least 10 μm above the low weld amplitude.

In an aspect, the initial period is just less than the time that it takes the material of the part adjacent the horn tip to soften. In an aspect, the time period is about 0.2 seconds. In an aspect, the initial period is about 0.4 seconds. In an aspect, the initial period is about 0.5 seconds. In an aspect, the initial period is in the range of about 0.2 to about 0.6 seconds.

A study using the above described amplitude profiling welding was conducted for welding aluminum using a Branson Lateral Drive Weld system. Time was used as the trigger point method to determine when to switch amplitudes.

Three basic amplitude control techniques were evaluated; 60 μm-43 μm, 60 μm, and 40 μm. In addition the welding was performed on three different anvil styles; standard flexible, a fixed anvil with a loosened anvil block, and a fixed anvil with a secured anvil block. The study included the various anvil styles in order to determine if either of the particular designs offered an advantage in combination with the amplitude control methods. The fixed anvil design is essentially a large anvil block that is fixed to the lateral drive base plate. Within the fixed anvil block there is a removable anvil block. This anvil block can be rigidly attached to the anvil or allowed to “float”. It has been seen in prior experiments that there is a distinct difference in weld performance and strength depending on whether the anvil block is rigidly attached (fixed AB) or allowed to float (loose AB). A matrix showing the various test combinations is shown below.

| | | Amplitude |
|---|---|---|
| Test | Anvil | Control |
| 1 | Flexible | 60 um-43 um, .4 s |
| | | trig. |
| 2 | Flexible | 60 um |
| 3 | Flexible | 40 um |
| 4 | Fixed (loose AB) | 60 um-43 um, .2 s |
| | | trig. |
| 5 | Fixed (loose AB) | 60 um |
| 6 | Fixed (loose AB) | 40 um |
| 7 | Fixed (fixed AB) | 60 um-43 um, .2 s |
| | | trig. |
| 8 | Fixed (fixed AB) | 60 um |
| 9 | Fixed (fixed AB) | 40 um |

The time trigger point between the flexible and fixed anvils is 0.4 s and 0.2 s. This was done to ensure a consistent weld process between the two anvil styles and prevent overloads. For all of the tests the following weld system was used with the certain weld parameters fixed.

### Weld System: Lateral Drive

### Converter: 5.5 kW Branson Converter

### Tooling: Gold Booster (Gain 1.5), High Q Tool (Gain 1:1)

Horn: CL Rev 1 (Gain 1.8), max amplitude=63 um
Weld Pressure: 70 psi (700 lbs. Force)

### Aluminum Sample: 3 mm 5754

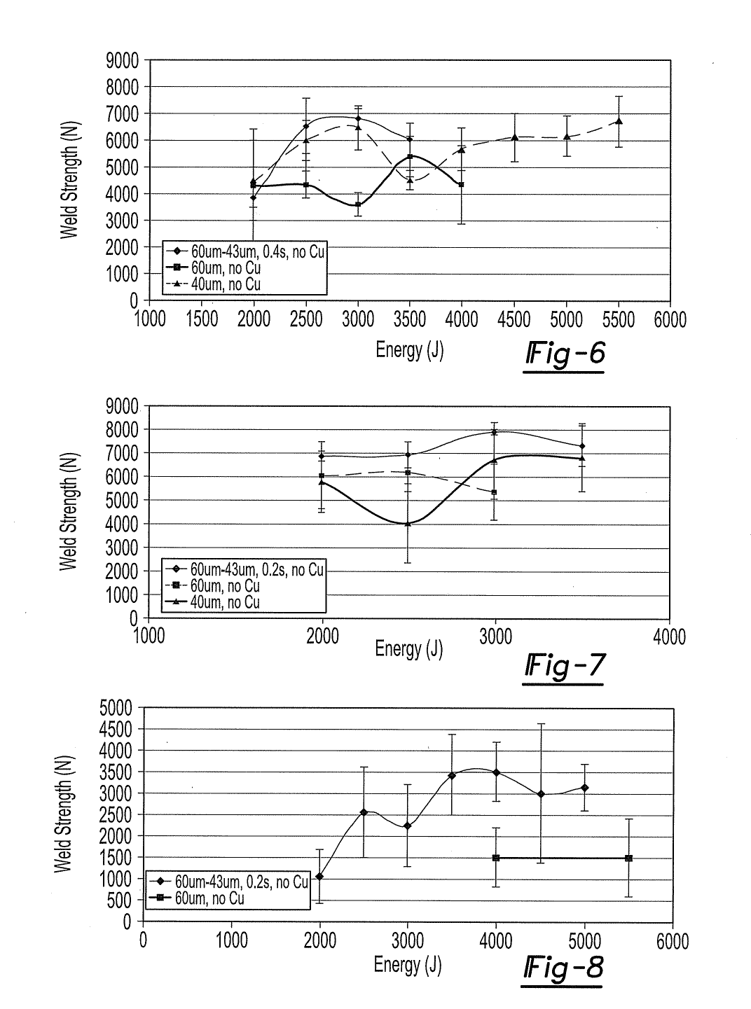

Each test produced a graph of pull strength vs. energy for each of the anvil types (for a total of 3 graphs shown in FIGS. 6-8). Each graph data point shows the average and standard deviation of 5 welds. To statistically verify these graphs, an expanded study was performed on selected data points of 25 welds.

Results from the study are shown in FIGS. 6-8. As can be seen, there is a clear difference in performance for the 3 anvil types. Superior pull strength performance is shown for both the flexible and fixed (loose AB) anvil types. The fixed (fixed AB) anvil shows general pull strengths approximately half of the other anvil types with very large scatter. As a result of the poor performance, test #9 was not performed due to an inability to generate a minimum number of data points.

As can be seen from the graphs of FIGS. 6-8, the tests appear to show a general pull strength performance enhancement with the amplitude profiling technique. Use of the flexible anvil does show areas where the 40 um welding approaches the strength of the amplitude profiling technique. The test results shown in FIGS. 6-8 do appear to show that fixed 40 um amplitude welding produces better strengths at lower energy settings, while 60 um welding shows better strengths at higher energy settings. Amplitude profiling appears to combine this effect by producing more consistent, higher pull strengths over a broader energy range.

The fixed anvil (loose AB) welding shows again that amplitude profiling produces more consistent weld strengths over a broad energy range. The high strength energies of the low amplitude and high amplitude settings appear opposite from the flexible anvil data. Use of 40 um weld amplitude with the fixed anvil (loose AB) produces high strength welds at higher energy settings while use of 60 um welding produces strong welds at the lower energy settings. Use of amplitude profiling, appears to combine these effects by produces stronger, more consistent welds over a broad energy range. The strengths produced from amplitude profiling at the 3000 J data point from the fixed anvil (loose AB) actually appears stronger (up to 8000N) than the weld strengths produced at the same energy level with the flexible anvil (up to 7000N).

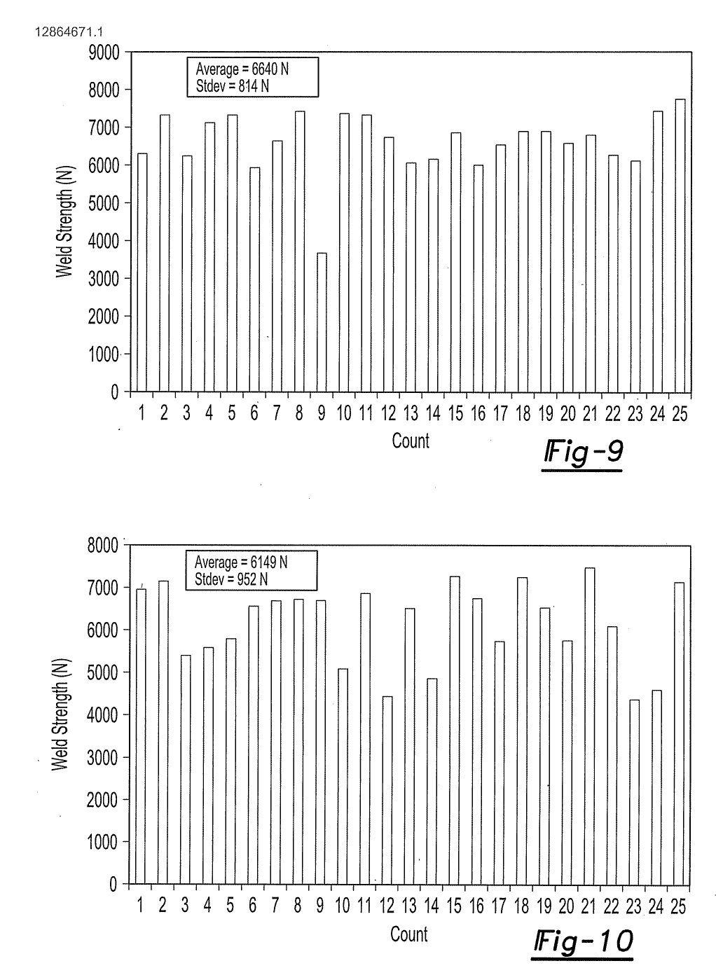

The profiling data showed that the average pull strength from the fixed (loose AB) was slightly better than the pull strength from the flexible anvil (8 kN to 6.8 kN) at 3000 J. To ensure that the results were not a result of the low sample sizes, a 25 sample run was made at 3000 J using amplitude profiling for both the flexible and fixed (loose AB) anvils. The results are shown in FIGS. 9 and 10 and indicate that the 3000 J point for the flexible and fixed (loose AB) are statistically equivalent.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of ultrasonic welding aluminum parts together, comprising:
placing the aluminum parts in an ultrasonic welding apparatus and contacting at least one of the aluminum parts with a horn tip of a weld horn of the ultrasonic welding apparatus; and
amplitude profiling a weld amplitude during a weld cycle by producing a high weld amplitude above 55 μm at the horn tip of the weld horn during an initial period of a weld cycle and producing a low weld amplitude below 55 μm at the horn tip after the initial period.

2. The method of claim 1 wherein producing the high weld amplitude includes producing a weld amplitude above 60 μm and producing the low weld amplitude includes producing a weld amplitude below 50 μm.

3. The method of claim 2 wherein producing the low weld amplitude below 50 μm includes producing the low weld amplitude below 45 μm.

4. The method of claim 1 wherein producing the high and low weld amplitudes includes producing the high and low weld amplitudes so that the high weld amplitude that is at least 10 μm above the low weld amplitude.

5. The method of claim 1 wherein the initial period is just less than a time that it takes the aluminum to begin to soften when being ultrasonically welded at the high weld amplitude.

6. The method of claim 1 wherein the initial period is about 0.2 seconds.

7. The method of claim 1 wherein the initial period is about 0.4 seconds.

8. The method of claim 1 wherein a trigger point for determining when to switch amplitudes is any of time, energy level or peak power value.

9. The method of claim 1 wherein the placing the aluminum parts in the ultrasonic welding apparatus includes placing aluminum parts that are each at least about 3 mm thick in the ultrasonic welding apparatus.
